(19) United States
(12) Patent Application Publication
(10) Pub. No.: US 2007/0164538 A1
(43) Pub. Date: Jul. 19, 2007

(54) Joint structure for a baby stroller

(75) Inventor: Chuan-Ming Yeh, Chuayi City (TW)

Correspondence Address: BIRCH STEWART KOLASCH & BIRCH, PO BOX 747, FALLS CHURCH, VA, 22040-0747, US

(73) Assignee: Link Treasure Limited

(21) Appl. No.: 11/653,959

(22) Filed: Jan. 17, 2007

(30) Foreign Application Priority Data
Jan. 18, 2006 (TW) 095201131

(51) Int. Cl. B62B 7/00

(52) U.S. Cl. 280/642

(57) ABSTRACT

A joint structure for a baby stroller comprises a articulated assembly connected to the rear leg tube of the stroller frame, and uses the articulated assembly controllable pivoted with the push bar and the front leg tube. The articulated assembly has an engaging pin for locking the push bar in a fixed position therefore to keep the stroller in a erected position. The engaging pin may pulled and disengaged from the end of the pull bar, and allows the push bar to rotate to collapse the stroller.

### FIELD OF THE INVENTION

The present invention relates to a joint structure for a walking aid, and more particularly, to a joint structure which can be operated between a collapsed position and an erected position.

### DESCRIPTION OF THE RELATED ART

Baby strollers usually provide with a frame capable of being extended in an expanded position for carrying babies and of being folded in a collapsed position. In order to control the operation of the baby stroller, an articulated device for folding the stroller frame is needed. The articulated device on a collapsible stroller normally includes a push bar connected with a upper joint element at its end portion, and a lower joint element provided with a locking notch and firmly attached to the upper end of a front leg tube. The push bar is slidably received a connecting rod for driving a latch element for latching in and getting back from the locking notch of the lower joint element. When the latch element is latched in the locking notch, the stroller is fixed in an expanded position, and if the latch element is pulled by the connecting rod and left from the locking notch, the stroller is recovery from the expanded position to a collapsed position for easy transportation and saving space.

The forementioned structure of the commercial available stroller has not enough strength, because the connection point between the push bar and front leg tube is only achieved by the latch element and the locking notch, thus easily causes a damage on the lower joint element and may abruptly and erroneously dismantled and folded to hurt the child therein.

Another related structure in the prior art as disclosed in the U.S. Pat. No. 5,605,049 uses a slidably upper joint engageable with the upper end of the front leg tube, for fixing the stroller in a erected position to provide a better strength for the structure. However, before engaging the slidably upper joint to the front leg tube, the user is needed to align the slidably upper joint parallel to the front leg tube carefully, or the engagement may not be fully accomplishd.

### SUMMARY OF THE INVENTION

In order to improve the stroller frame and avoid the problems about the structure strength, the present invention provides a new structure of a stroller frame, comprises a articulated assembly connected to the rear leg tube of the stroller frame, and uses the articulated assembly controllable pivoted with the push bar and the front leg tube.

The articulated assembly has an engaging pin for locking the push bar in a fixed position therefore to keep the stroller in a erected position. The engaging pin may be pulled and disengaged from the end of the pull bar, and allows the push bar to rotate to collapse the stroller. As the pushed bar is locked at the end, there can be obtained a good support strength and easy to accomplish a good smooth operation by user.

Additional objects and advantages of the invention will be set forth in the following description and it is easy for a person having ordinary skill in this art to infer other variations from above illustrations and embodiments. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and, together with the description, serve to explain the principles of the invention.

FIG. 1 is a side view of a embodiment of the present invention showing an articulated assembly connected to the rear leg tube and pivotally connected with the push bar and the front leg.

FIG. 2 is an exploded view of an embodiment of the articulated assembly according to the present invention.

FIG. 3 is a schematic perspective view showing the position of an engaging pin in a engaged position that limited the push bar from rotation and fixed the stroller frame in an erected position.

FIG. 4 is a schematic perspective view showing the engaging pin slidably received within a positioning bracket and guided by a slot thereof.

FIG. 5 is an enlarged schematic view showing a locking mechanism limited the folding between the upper portion and lower portion of the push bar.

FIG. 6 is an enlarged schematic view showing the locking mechanism released the limitation of the folding between the upper portion and lower portion of the push bar.

FIG. 7 is an enlarged schematic view showing the engaging pin limited the rotation of the push bar.

FIG. 8 is an enlarged schematic view showing the engaging pin dismissed the limitation, and allows the push bar rotated to an angle.

FIG. 9 is a schematic view showing the engaging pin slidably moved to dismiss the limitation, and allows the push bar to rotate to an angle.

FIG. 10 is a schematic side view showing the directions of folding the stroller of the present embodiment.

FIG. 11 is a schematic side view showing the folding status the stroller of the present embodiment.

FIG. 12 is a schematic side view showing an alternative embodiment according to the present invention.

FIG. 13 is a schematic side view showing another alternative embodiment according to the present invention.

### DETAILED DESCRIPTION OF THE PREFERRED EMBODIMENTS

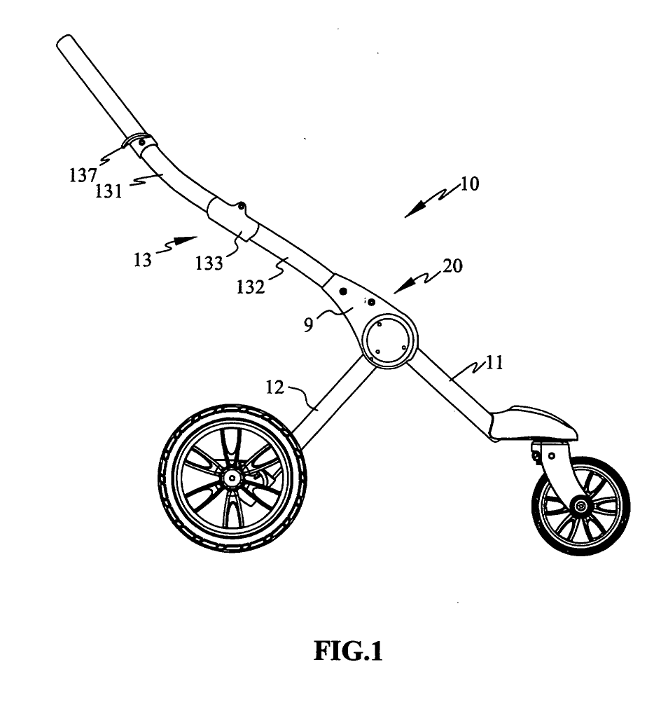

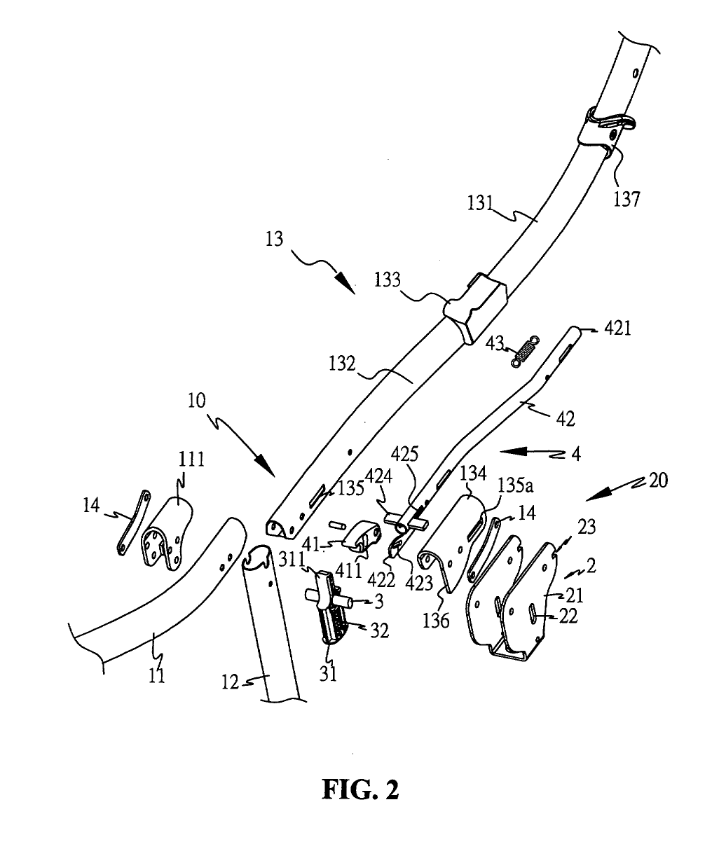

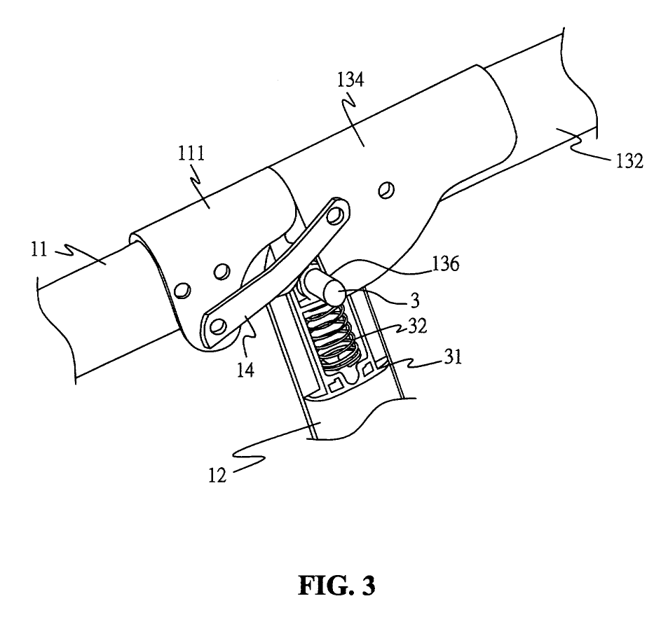

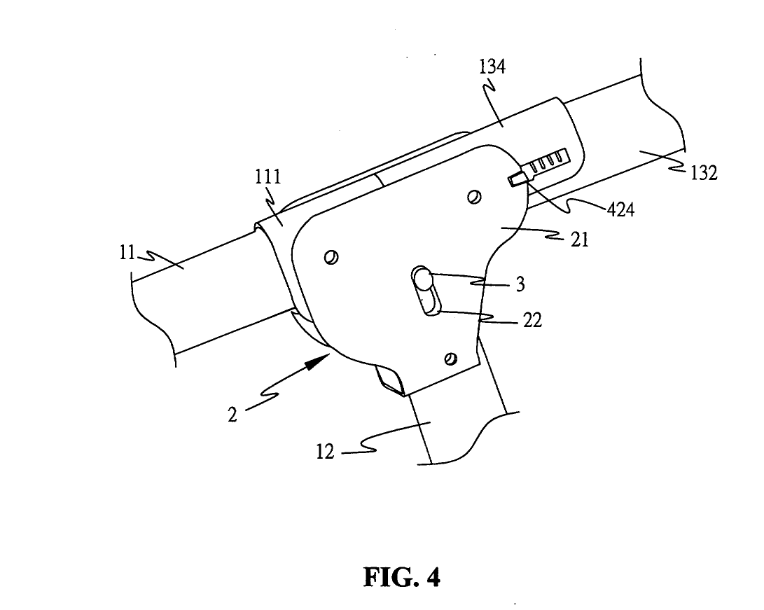

Referring to FIGS. 1 to 4, an embodiment of the present invention comprises an articulated assembly 20 controllably equipped on a stroller frame 10 stroller frame 10 has a front leg tube 11, rear leg tube 12 and a push bar 13.

The upper end of the front leg tube 11 connected with a lower holding element 111 and a connecting element 14. The lower holding element 111 may be a U-shaped bracket and made of metal or high strength engineering plastic. The lower connecting element 14 is pivotally connected between the front leg tube 11 and the push bar 3 either directly or indirectly.

The push bar 13 includes a upper portion 131, a lower portion 132 a locking mechanism 133, a upper holding element 134 and a hooked element 137. The locking mechanism 133 is provided for controllably connecting the upper portion 131 and the lower portion 132. The hooked element 13 is removably connected with the upper holding element 134 and having a connecting means (not shown) connected with the locking mechanism 133.

The end of lower portion 131 of the push bar 13 is formed with a slot 135 and connected with the upper holding element 134 and the connecting element 14. The upper holding element 134 has a slot 135a and an abutting edge 136, said slot 135a is aligned with the slot 135 of the end of lower portion 131 for receiving and guiding a pin for reciprocally sliding therein.

The articulated assembly 20 is connected to the upper end of the rear leg tube 12 and includes a positioning bracket 2, a engaging pin 3 and a release device 4. The positioning bracket 2 is formed with a pair of side walls 21, a slot and a positioning notch 23. Between the pair of side walls 21, positioning bracket 2 pivotally connects the front leg tube 11 and the push bar 12, thus allows the front leg tube 11 and the push bar 12 can be rotated to close to each other. Preferably, for safety, a cover is provided to cover on the outside of the positioning bracket 2, to prevent a user's finger grabbed in and accidentally hurt by the rotation of tubes

The engaging pin 3 connects with a slider 31, a resilient element 32 and a extended portion 311. The engaging pin 3 is slidably connected between the pair of side walls 21 of the positioning bracket 2, and guided by the slots 22 on the side walls 21. In the present embodiment, the slider 31 is slidably received within positioning bracket 2 and biased by the resilient element 32 and kept the engaging pin 3 abutted against the upper end of the slots 22 of the positioning bracket 2.

While the stroller frame 10 is erected, the engaging pin 3 limits the rotation of the push bar 13 by moving into the position contacted with the abutting edge 136 of the upper holding element 134.

The release device 4 includes a driving element 41, a connecting element 42 and a resilient element 43. The driving element 41 has arched slot 411 and a pin hole pivotally connected in the lower portion 132 of the push bar 13. The connecting element 42 movably received in the lower portion 132 of the push bar 13, has a free end 421, an extending tab 422, skewed slot 423, positioning pin 424 and a resilient element 425.

The resilient element 43 has one end connected with the inside of the lower portion 132 of the push bar 13, and one end connected with the connecting element 42 for biasing the free end 421 abutting the inside of the locking mechanism 133.

The extending tab 422 is formed on the other end of the connecting element 42 and pivoted with driving element 41 via the skewed slot 423. The positioning pin 424 is laterally extending from the end of the connecting element 42 and movably biased by the resilient element 425 for engaging into the positioning notch 23 of the positioning bracket 2.

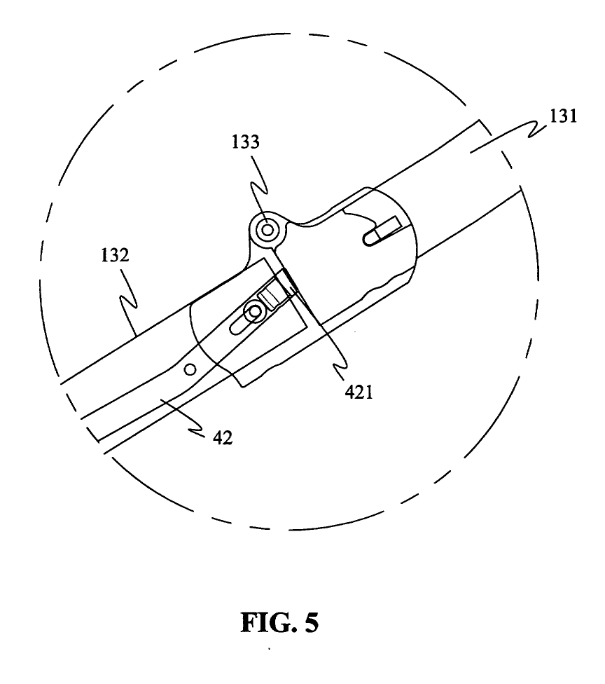

As shown in FIG. 5, when the stroller frame 10 is in an erected position, the locking mechanism 133 is locked the upper portion 131 and lower portion 132 in a substantially straight configuration.

Referring again to FIG. 1, a user can fold the stroller frame 10 by pull the hooked element 137 to slide along the upper portion 131 of the push bar 13 and release the locking mechanism 133 from the locked position. When the locking mechanism 133 is released, the upper portion 131 is rotatable to close to the lower portion 132.

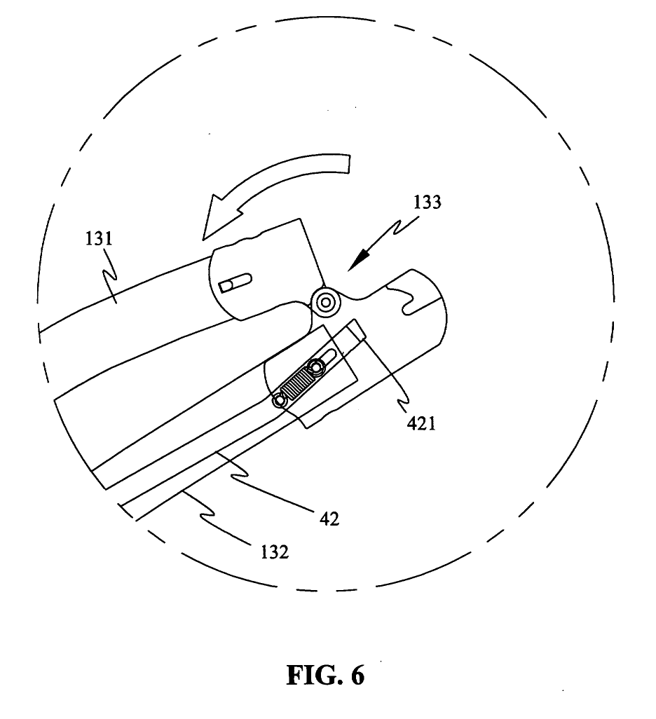

Referring to FIG. 6, when the upper portion 131 is rotated and closed to the lower portion 132, the free end 421 of the connecting element 42 is departed from the end of the upper portion 131 and moved upward by the biasing of the resilient element 43.

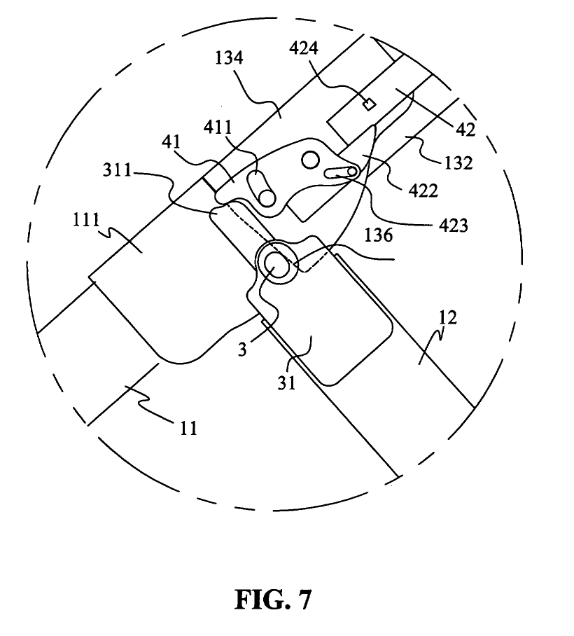

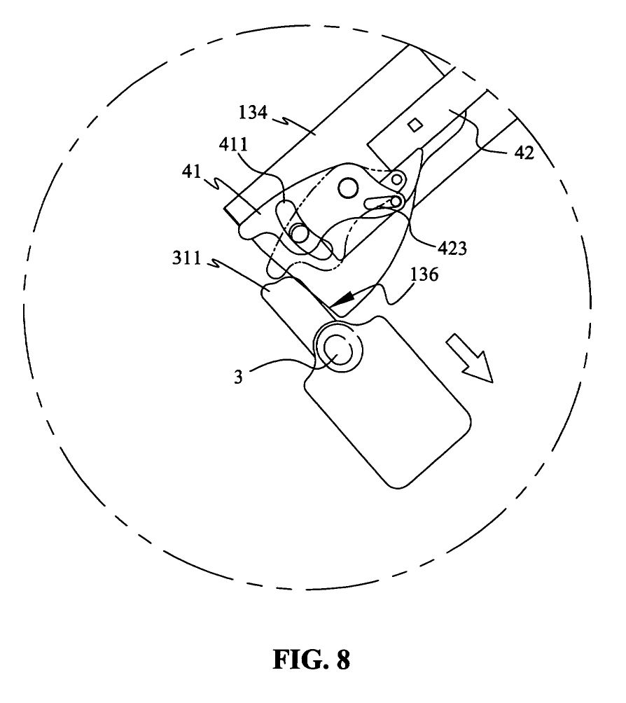

Referring to FIGS. 7 and 8, while the connecting element 42 is moving upward, the position pin 424 is leaving the positioning notch 23 of the positioning bracket 2, and the skew 423 of the extending tab 422 forces the driving element 41 to rotate and press down the extended portion 311 of the engaging pin 3. This makes the engaging pin 3 left the abutting edge 136 of the upper holding element 134. When the engaging pin 3 left the abutting edge 136, the lower portion 132 of the push bar 13 is rotatable to close the rear leg tube 12.

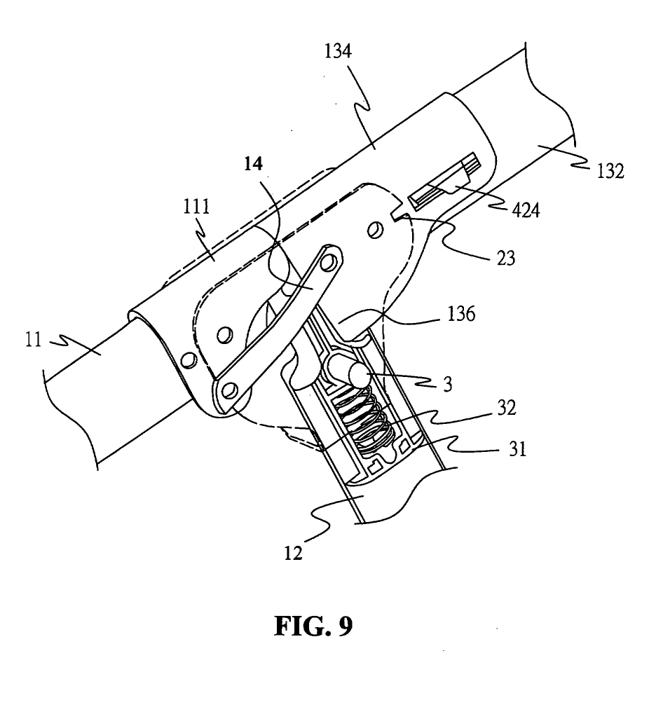

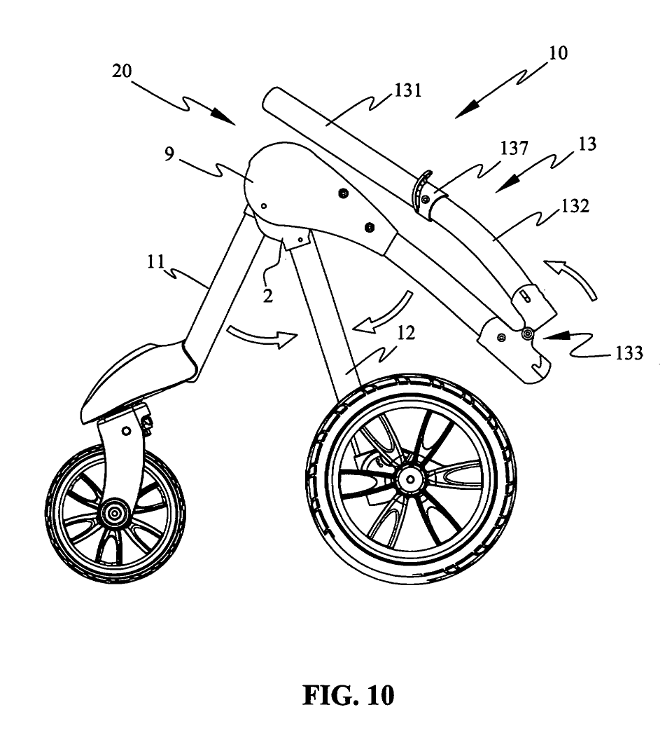

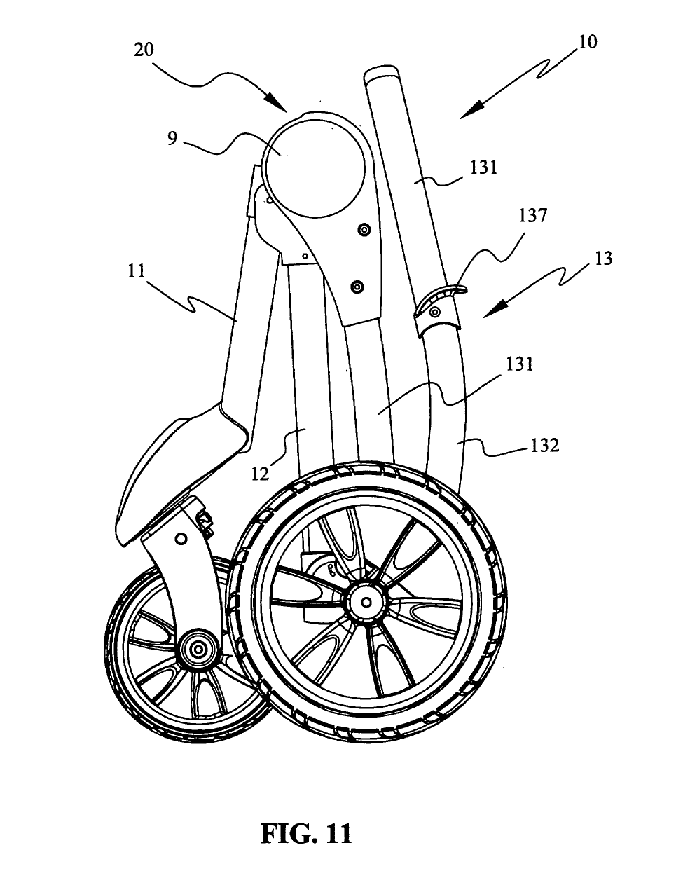

Referring to FIG. 9, when the push bar 13 is rotated, the connecting element 14 carries the front leg tube 11 to rotate toward the rear leg tube 12 as the arrows shown the directions in FIG. 10 until the collapsed position shown in FIG. 11.

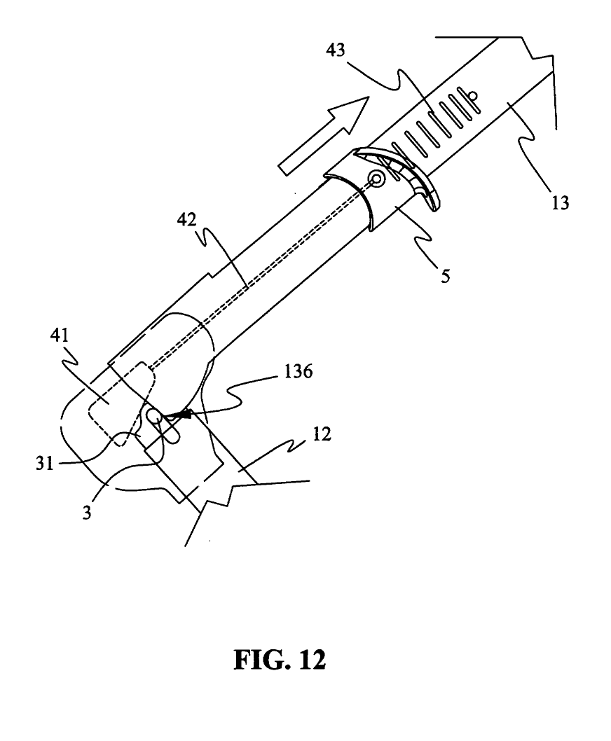

Referring to FIG. 12, an alternative embodiment has a push bar 13 formed with an abutting edge 136, connects a hooked element 5, a driving element 41, connecting element 42, and a resilient element 43. The main difference between the present embodiment and the previous embodiment is the handle bar 13 which equipped without the locking mechanism 133 as shown in FIG. 10. The hooked element 5 is movably connected with the push bar 13. It is possible to drive a driving element 41 via such a connecting element 42 by pulling the hooked element 5 against the biasing force form a resilient element 43.

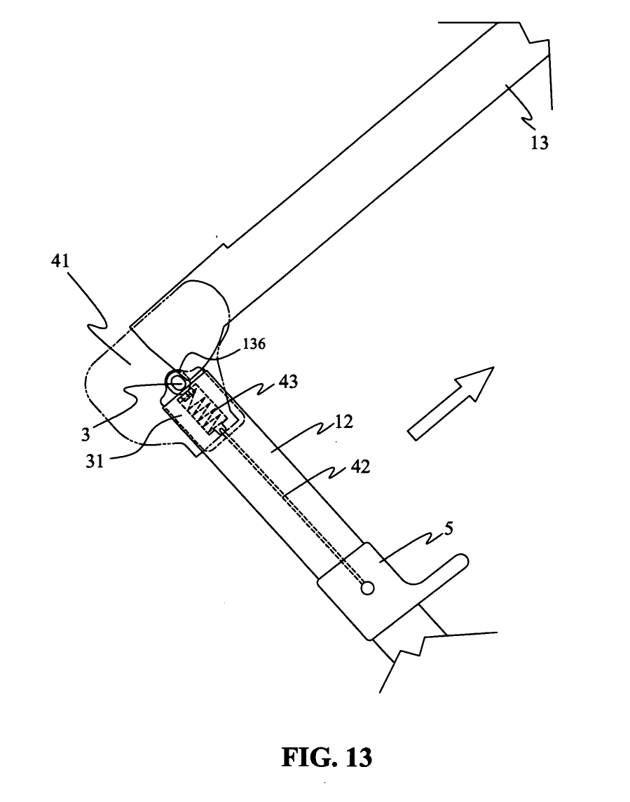

There is a further alternative embodiment as shown in the FIG. 13. In this alternative embodiment, the hooked element 5, the connecting element 42, the resilient element 43 are operatively connected with the rear leg tube 12. The engaging pin 3 and the slider 31 are pulled by the hooked element 5 via the connecting element 42 when start to folding the stroller frame 10. The user may drive the hooked element 5 by foot to start the folding operation.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A joint structure for a baby stroller, comprising:
a stroller frame, having a push bar, a front leg tube and a rear leg tube;
a positioning bracket, connected with the upper end of the rear leg tube, and pivotally connected with the front leg tube and the push bar of the stroller frame;
an engaging pin, slidably connected within the positioning bracket for controllably abutting against the end of the push bar, and
a release device, operatively connected between the engaging pin and the stroller frame for controlling the engaging pin to move away from the end of the push bar.

2. The joint structure for a baby stroller of claim 1, wherein the front leg tube and the push bar of the baby stroller are pivotally connected with a connecting element.

3. The joint structure for a baby stroller of claim 1, wherein the push bar having one end formed with a abutting edge for abutting with the engaging pin to stop the rotation of the push bar.

4. The joint structure for a baby stroller of claim 1, wherein the positioning bracket having a pair of side walls, the pair of side walls having a slot for guiding the movement of the engaging pin.

5. The joint structure for a baby stroller of claim 1, wherein the engaging pin is biased by a resilient element to a position to stop the rotation of the push bar.

6. The joint structure for a baby stroller of claim 1, wherein the release device is operatively received in the push bar.

7. The joint structure for a baby stroller of claim 1, wherein the release device includes a driving element, a connecting element and a hooked element, and the hooked element is operatively connected with the stroller frame for driving the driving element via the connecting element.

8. The joint structure for a baby stroller of claim 1, wherein the hooked element is operatively connected with the push bar of the stroller frame.

9. The joint structure for a baby stroller of claim 1, wherein the hooked element is operatively connected with the rear leg tube of the stroller frame.

10. The joint structure for a baby stroller of claim 1, wherein the side walls of the positioning bracket having a positioning notch for engaging with a positioning pin which laterally extended from the release device.

11. The joint structure for a baby stroller of claim 1, wherein the release device includes a connecting element having one end laterally extended a positioning pin and formed an extending tab.

12. The joint structure for a baby stroller of claim 11, wherein the extending tab having a skewed slot for guiding a pin to drive a driving element to move the engaging pin.
